(19) United States
(12) Patent Application Publication
(10) Pub. No.: US 2014/0298447 A1
(43) Pub. Date: Oct. 2, 2014

(54) Method for Enhancing Security of Portable Electronic Device and Related Wireless Charging System

(71) Applicant: HTC Corporation, Taoyuan County (TW)

(72) Inventor: Feng-Seng Chu, Taoyuan County (TW)

(21) Appl. No.: 14/228,281

(22) Filed: Mar. 28, 2014

Related U.S. Application Data
(60) Provisional application No. 61/805,936, filed on Mar. 28, 2013.

(51) Int. Cl. H04W 12/08; H04L 29/06

(52) U.S. Cl. CPC H04W 12/08; H04L 63/0876
USPC 726/18

(57) ABSTRACT

A method for a portable electronic device for enhancing the security of the portable electronic device while charged wirelessly by a power transmission device includes sending a first packet including a security code of the portable electronic device to the power transmission device for starting wireless charging; being charged wirelessly by the power transmission device; and reporting a second packet including the security code to the power transmission device according to a triggering event.

### CROSS REFERENCE TO RELATED APPLICATIONS

This application claims the benefit of U.S. Provisional Application No. 61/805,936, filed on Mar. 28, 2013 and entitled “Method and Apparatus to avoid unaware replacing of power receiver in wireless charging systems”, the contents of which are incorporated herein in their entirety.

### BACKGROUND OF THE INVENTION

1. Field of the Invention

The present invention relates to a method used in a wireless charging system and related wireless charging device, and more particularly, to a method of enhancing the security of a portable electronic device in a wireless charging system and related wireless charging device.

2. Description of the Prior Art

With the proliferation of portable electronic devices such as mobile device, smart phone and tablet PC, the demand for charging devices, especially for those provided in public areas, is increasing. In addition, people would like to get rid of annoying wires if possible. One technology which realizes this desire is wireless charging, in which portable electronic device(s) comprising a power receiver is placed on and charged through a power transmission device (e.g. a power base station comprising a power transmitter). Therefore, the current trend is towards providing wireless charging in public areas so that people can easily find a wireless power supply to charge their portable electronic devices.

Wireless Power Consortium (WPC) is a leading organization in the world to define wireless charging specification. The document Wireless Power Transfer—Volume I, part I in version 1.1.1 released in July 2012 has specified the communication protocol between a power transmitter and a power receiver. Section 5.2.3 of the document, specifying power transfer from transmitter perspective in system control, defines that during the power transfer the power transmitter expects to receive the following packets with corresponding timing constraints.

Control Error Packet

Received Power Packet

Charge Status Packet

End Power Transfer Packet

Any Proprietary Packet

Any reserved Packet

FIG. 1 shows power transfer phases 10 in a wireless charging system defined in the Wireless Power Transfer specification. As shown in FIG. 1, power transfer from a power transmitter to a power receiver comprises four phases, namely the selection phase 100, the ping phase 102, the identification & configuration phase 104, and the power transfer phase 106. As soon as the power transmitter applies a power signal, the power receiver may enter the selection phase 100. If the power receiver considers the rectified voltage to be sufficiently high, the power receiver may proceed to the ping phase 102 to transmit the first packet. After the power receiver has transmitted a Signal Strength Packet, the power receiver shall proceed to the identification & configuration phase 104. In the identification & configuration phase 104, the power transmitter identifies the selected power receiver, and obtains configuration information such as the maximum amount of power that the power receiver intends to provide at its output (to a portable electronic device where the power receiver is installed). The configuration information is used to characterize the power transfer in the following power transfer phase 106.

During the power transfer phase 106, the power transmitter continues to provide power to the power receiver, and adjust supplied power in response to control data received from the power receiver. The control data may be included in the Control Error Packet which is transmitted periodically (e.g. in every 1.5 second) from the power receiver to the power transmitter during the power transfer. When the battery of the portable electronic device is fully charged, the power receiver may request to terminate the power transfer by transmitting an End Power Transfer Packet to the power transmitter so as to revert the wireless charging system to the selection phase 100 from the power transfer phase 106. On the other hand, if the battery of the portable electronic device has already been fully charged at the beginning of the power transfer phases 10, the wireless charging system may be reverted to the selection phase 100 upon the power transmitter receiving an End Power Transfer Packet in the ping phase 102, without entering the identification & configuration phase 104 and the power transfer phase 106.

While the power transmission device is charging a mobile device M1, the power transmitter in the power transmission device expects to receive the Control Error Packet from the power receiver in the mobile device M1 within 1.5 seconds. If, for example, the mobile device M1 is replaced by another device M2 with a fully-charged battery in 1 second and the device M2 receives the power signal from the power transmitter, entering the ping phase 102 and sending an End Power Transfer Packet to the power transmitter in 40 milliseconds, the power transmitter may consider that the power transfer is terminated normally. In other words, if one mobile device is taken away and replaced by another mobile device with a fully-charged battery, the power transmission device may terminate the power transfer normally without noticing any abnormal conditions. Knowing this security vulnerability, a thief may take away an expensive mobile device while it is charged wirelessly and replace the expensive mobile device by a cheap device with a fully-charged battery to deceive the power transmission device.

Therefore, how to prevent the portable electronic device from being stolen by taking advantage of the abovementioned security vulnerability is a topic to be addressed and discussed in the industry.

### SUMMARY OF THE INVENTION

An objective of the present invention is to provide a method and related wireless charging device and wireless charging system capable of detecting whether the portable electronic device is taken away without permission and is replaced by other device. Thus, the security of the portable electronic device is enhanced, which is especially useful when the portable electronic device is charged wirelessly in a public space.

The present invention discloses a method for a portable electronic device for enhancing the security of the portable electronic device while charged wirelessly by a power transmission device. The method includes sending a first packet including a security code of the portable electronic device to the power transmission device for starting wireless charging; being charged wirelessly by the power transmission device; and reporting a second packet including the security code to the power transmission device according to a triggering event.

The present invention further discloses a method for a portable electronic device for enhancing the security of the portable electronic device while charged wirelessly by a power transmission device. The method includes sending a first packet including a security code of the portable electronic device to the power transmission device for starting wireless charging; and constantly reporting a second packet including the security code to the power transmission device while being charged wirelessly by the power transmission device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of power transfer phases in a conventional wireless charging system.

FIG. 2 is a schematic diagram of a wireless charging system according to an example of the present invention.

FIG. 3 is a functional block diagram of a wireless charging system according to an example of the present invention.

FIG. 4 is a flowchart of a process according to an example of the present invention.

FIG. 5 is a flowchart of a process according to an example of the present invention.

FIG. 6 is a flowchart of a process according to an example of the present invention.

### DETAILED DESCRIPTION

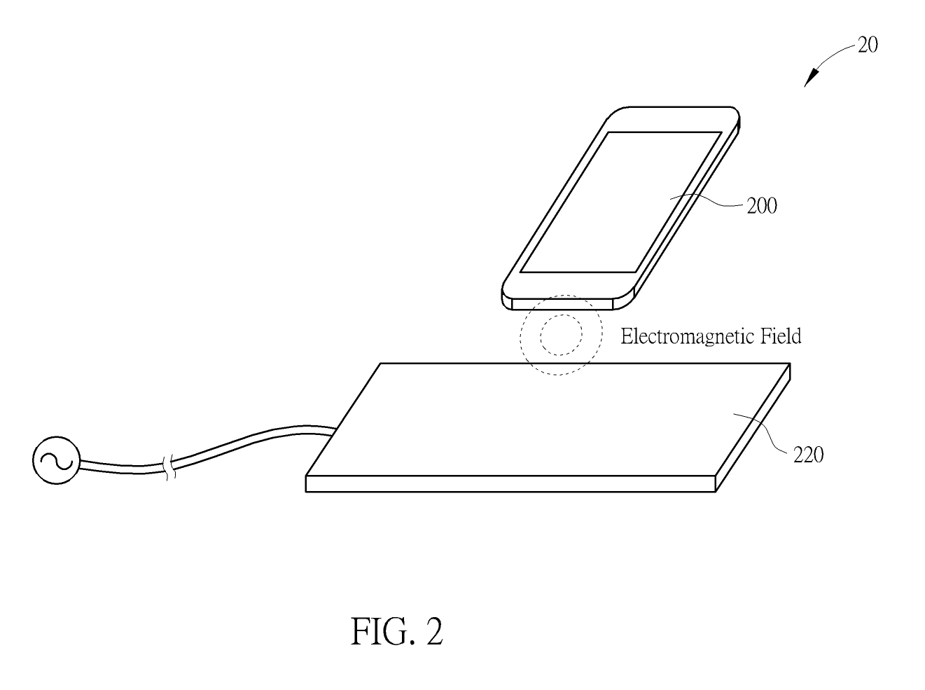

Please refer to FIG. 2, which illustrates a schematic diagram of a wireless charging system 20 according to an example of the present disclosure. A wireless charging system may include at least one power transmission device and at least one portable electronic device that can be charged by the power transmission device. For simplicity, in FIG. 2, the wireless charging system 20 is briefly composed of a portable electronic device 200 and a power transmission device 220. The power transmission device 220 may represent a power base station, including a power transmitter or a power transmitting module with digital/analog chip(s), to supply wireless power to the portable electronic device 200. The portable electronic device 200 may be a mobile phone, a laptop, a tablet computer, an electronic book, a portable computer system, any other mobile devices or at least a power receiver or a power receiving module. Alternatively, the portable electronic device 200 may be any electronic device using battery as its power supply, such as a wearable computing device, a wearable medical device, a portable MP3 player, etc. The portable electronic device 200 may directly attach to the power transmission device 220 or keep within a distance from the power transmission device 220 for wireless charging. As shown in FIG. 2, the portable electronic device 200 receives wireless power from the power transmission device 220 by electromagnetic induction so that the battery of the portable electronic device 200 is charged without using any wire connection.

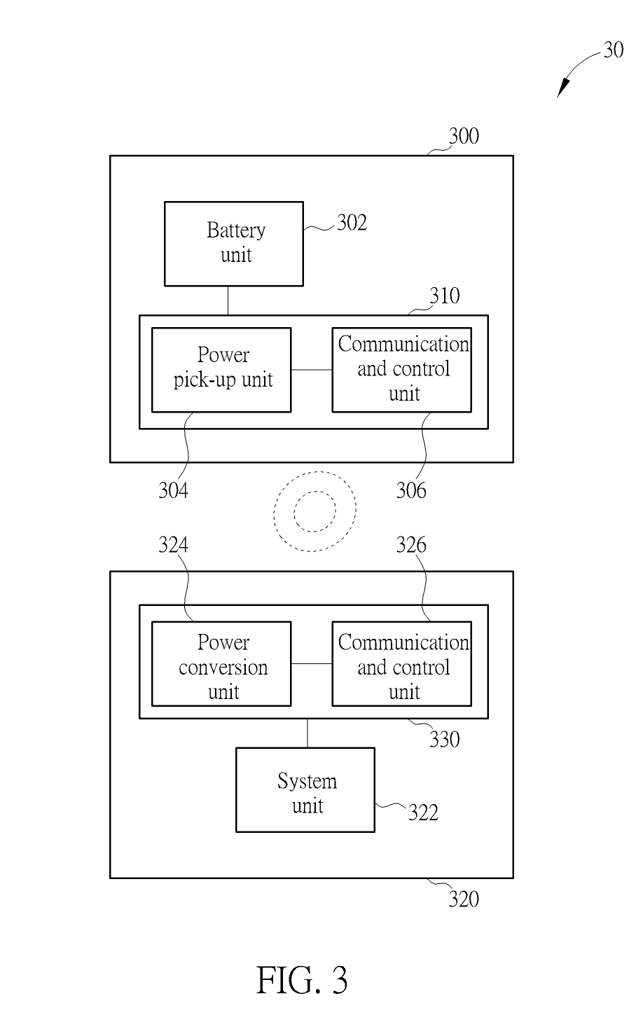

Please refer to FIG. 3, which is a functional block diagram of a wireless charging system 30 according to an example of the present invention. The wireless charging system 30 includes a portable electronic device 300 and a power transmission device 320. The portable electronic device 300 may be the portable electronic device 200 shown in FIG. 2, and the power transmission device 320 may be the power transmission device 220 shown in FIG. 2. The portable electronic device 300 includes a battery unit 302 and a power receiver 310. The power receiver 310 may include a power pick-up unit 304 used for receiving wireless power to charge the battery unit 302 and a communication and control unit 306 used for communicating, i.e., sending/receiving signals or packets, with the power transmission device 320 via power signals and controlling the operation of the power pick-up unit 304.

The power transmission device 320 includes a power transmitter 330 and a system unit 322. The power transmitter 330 may include a power conversion unit 324 used for supplying wireless power and a communication and control unit 326 used for communicating, i.e., sending/receiving signals or packets, with the portable electronic device 300 and controlling the operation of the power conversion unit 324. The system unit 322 may include a processing means such as a microcontroller, microprocessor or an Application Specific Integrated Circuit (ASIC), for handling a protection function activated by a processing result of the power transmitter 330. In the example of FIG. 3, the power transmission device 320 contains one power transmitter 330. In other examples, the power transmission device may contain multiple power transmitters for supplying wireless power to multiple portable electronic devices.

The communication and control units 306 and 326 preferably utilize the in-band communication channel for communication (e.g. by using load modulation), in which communication signals are carried on the wireless power. Alternatively, the communication and control units 306 and 326 may be implemented by radio transceivers that transmit and receive radio signals (e.g., messages, emails, or packets) in an out-band communication channel (e.g. a short-range communication protocol such as Bluetooth).

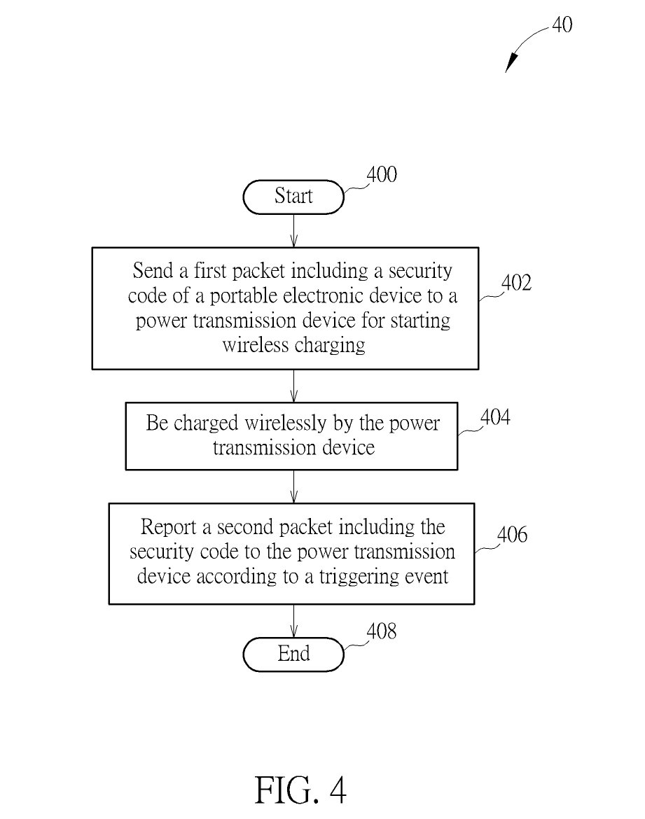

Please refer to FIG. 4, which is a flowchart of a process 40 according to an example of the present invention. The process 40 is utilized for a wireless charging system, such as the wireless charging systems 30 shown in FIG. 3, to enhance the security of the portable electronic device 300 while being charged wirelessly. The process 40 may be implemented by the power receiver 310 of the portable electronic device 300 and may be compiled into a program code to instruct a processing means such as a microcontroller, microprocessor or an Application Specific Integrated Circuit (ASIC) in the power receiver 310 to execute the following steps:

Step 400: Start.

Step 402: Send a first packet including a security code of a portable electronic device to a power transmission device for starting wireless charging.

Step 404: Be charged wirelessly by the power transmission device.

Step 406: Report a second packet including the security code to the power transmission device according to a triggering event.

Step 408: End.

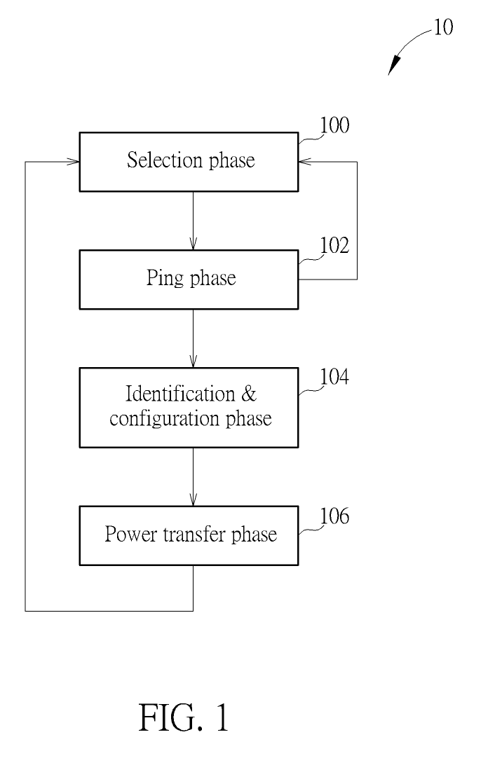

According to the process 40, the portable electronic device 300 starts the wireless charging by the power receiver 310 sending a first packet including a security code which identifies the portable electronic device 300. The security code may be included in a configuration packet (as the first packet) or be sent with a configuration packet during the identification & configuration phase 104 shown in FIG. 1. If the security code sent by the power receiver 310 of the portable electronic device 300 in the first packet is correct, the wireless charging system 30 enters the power transfer phase 106 and the power transmitter 330 of the power transmission device 320 starts to supply wireless power. While the power receiver 310 is charged wirelessly, i.e. receives power via a wireless channel (e.g. during the power transfer phase 106), the power receiver 310 may transmit the security code again according to a triggering event, i.e., report a second packet including or with the security code based on the occurrence of a triggering event. The triggering event could be a wireless charging stopping signal such as an End Power Transfer Packet released by the portable electronic device 300 when the battery unit 302 of the portable electronic device 300 is fully-charged, for example.

In normal conditions, the security code included in the second packet transmitted according to the triggering event should match the security code included in the first packet. If the power transmission device 320 receives the second packet and determines that the security code included in the received second packet does not match the security code included in the received first packet, the power transmission device 320 may determine that an abnormal condition happens and then activate certain functions to handle the abnormal condition. For example, the power transmission device 320 may activate a protection function such as releasing a warning signal and/or sending a message to a specific person or a place for asking help. In addition, the power transmission device 320 may transmit a signal or message to the portable electronic device 300 to instruct the portable electronic device 300 to launch a function or an application for reporting its location. The location report may be transmitted through a wireless communication protocol, such as the 3G or the LTE (Long-Term Evolution) protocol, to the power transmission device 320, or other user device or control system for tracking the location of the lost portable electronic device 300. Thus, if the portable electronic device 300 is replaced by another device and is taken away without permission, the power transmission device 320 can be aware of the situation based on the report and take prompt action to protect the portable electronic device 300.

Note that the process 40 is an example of the present invention. Those skilled in the art should readily make combinations, modifications and/or alterations on the abovementioned description and examples. For example, the triggering event is not limited to an event when wireless charging is stopped. The triggering event could be identified when any phase transition happens (e.g. from the power transfer phase 106 to the selection phase 100), when a command is received from the power transmission device 320 or when any unexpected event occurs such as missing packet, receiving unexpected packet, decoding packet incorrectly, or a timeout event occurs where an expected packet is not received within a specific duration. Alternatively, the triggering event could be the event when a packet such as the Control Error Packet is transmitted repeatedly. As such, the portable electronic device 300 may constantly report the security code (e.g., in the Control Error Packet) to the power transmission device 320 while being charged wirelessly by the power transmission device 320. In another example, the portable electronic device 300 may report the security code to the power transmission device 320 periodically or non-periodically.

The security code may be a number and/or characters uniquely identifying the portable electronic device 300. The security code may comprise full, partial or a logic operation of the manufacture code of the portable electronic device 300, the basic device identifier of the portable electronic device 300, the extended device identifier of the portable electronic device 300 and/or an identity of the portable electronic device 300, and/or a code assigned by the power transmission device 320 or a random number generated by the portable electronic device 300. An example of an identity of the portable electronic device 300 may be a mobile device identity for wireless communication such as the Radio Network Temporary Identifier (RNTI) and the Mobile Station International Subscriber Directory Number (MSISDN) defined in 3GPP specifications. For example, the portable electronic device 300 may generate the security code by an exclusive-OR (XOR) operation of certain bytes of the basic device identifier, or by combining the first byte of the manufacture code and the last two bytes of the basic device identifier of the portable electronic device 300.

The security code maybe sent in a dedicated packet to the power transmission device 320. That is, the first or the second packet may carry the security code only. In other examples, the first or the second packet may contain other information in addition to the security code. In one example, the first or the second packet may carry the other information which is encoded (e.g. scrambled) with the security code. For example, the content of the second packet may be generated by taking an exclusive-OR operation on the End Power Transfer and the security code. Or, the second packet may be an end of power transfer packet such as the End Power Transfer Packet defined in the WPC specification, and the security code may be inserted in the End Power Transfer Packet. In another example, the portable electronic device 300 may simply transmit the security code in a dedicated, separate packet right behind the End Power Transfer Packet.

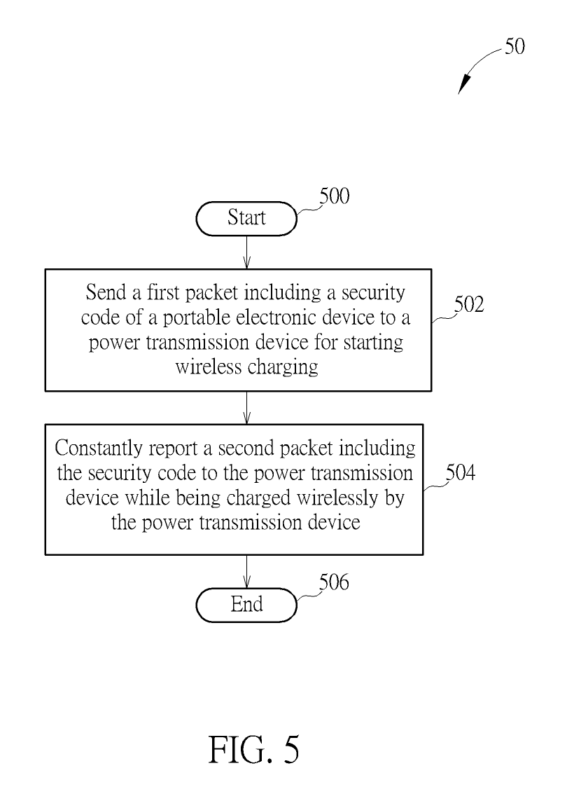

Please refer to FIG. 5, which is a flowchart of a process 50 according to an example of the present invention. The process 50 is utilized for a wireless charging system, such as the wireless charging systems 30 shown in FIG. 3, to enhance the security of the portable electronic device 300 while being charged wirelessly. The process 50 may be implemented by the power receiver 310 and may be compiled into a program code to instruct a processing means such as a microcontroller, microprocessor or an Application Specific Integrated Circuit (ASIC) in the power receiver 310 to execute the following steps:

Step 500: Start.

Step 502: Send a first packet including a security code of a portable electronic device to a power transmission device for starting wireless charging.

Step 504: Constantly report a second packet including the security code to the power transmission device while being charged wirelessly by the power transmission device.

Step 506: End.

According to the process 50, the portable electronic device 300 starts the wireless charging by the power receiver 310 sending a first packet including a security code which identifies the portable electronic device 300. The first packet maybe a configuration packet transmitted during the identification & configuration phase 104 shown in FIG. 1, and the security code may be included in the configuration packet as well. Alternatively, the first packet may be an additional packet different than the configuration packet. In such a case, the power receiver 310 of the portable electronic device 300 may send the configuration packet and send the additional packet including the security code right behind. If the security code sent by the power receiver 310 of the portable electronic device 300 in the first packet is correct, the wireless charging system 30 enters the power transfer phase 106 and the power transmitter 330 of the power transmission device 320 starts to supply wireless power. While the power receiver 310 is charged wirelessly (e.g. during the power transfer phase 106), the power receiver 310 may transmit the second packet including the security code repeatedly. The second packet maybe sent in a specific periodicity. The power transmission device 320 may also allow the portable electronic device 300 to report the second packet including the security code non-periodically.

In normal conditions, the security code included in the second packet should match the security code included in the first packet. If the power transmission device 320 receives the second packet and determines the security code included in the received second packet does not match the security code included in the received first packet, the power transmission device 320 may determine that an abnormal condition happens and then activate certain functions to handle the abnormal condition. For example, a protection function, such as releasing a warning signal, launch a function or an application for reporting a location of the portable electronic device 300 and/or sending a message to a specific person or a place for asking help, may be activated in response to the abnormal condition. Therefore, the portable electronic device 300 may be prevented from being replaced by another device and being taken away without permission. Consequently, the security of the portable electronic device 300 is enhanced.

Note that the process 50 is an example of the present invention. Combinations, modifications and/or alterations similar to the description and examples for the process 40 may be applied to the process 50 as well. For example, the portable electronic device 300 may report its identity as the security code to the power transmission device 320 in every 20 milliseconds. Assuming the Basic Device Identifier contains 4 bytes including the Ext bit, the security code maybe defined as one byte which is equal to an exclusive-OR operation of the 4 bytes of the Basic Device Identifier. This security code may be delivered in a dedicated packet which carries the security code only.

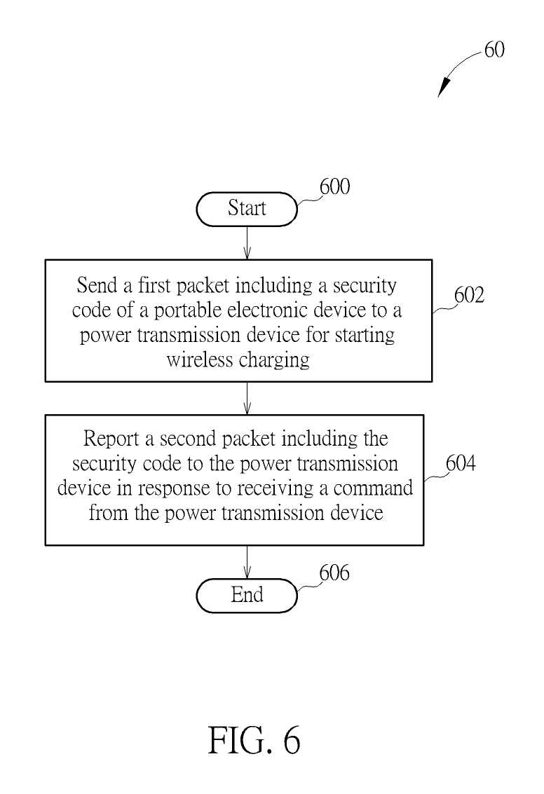

Please refer to FIG. 6, which is a flowchart of a process 60 according to an example of the present invention. The process 60 is utilized for a wireless charging system, such as the wireless charging systems 30 shown in FIG. 3, to enhance the security of the portable electronic device 300 while being charged wirelessly. The process 60 may be implemented by the power receiver 310 and may be compiled into a program code to instruct a processing means such as a microcontroller, microprocessor or an Application Specific Integrated Circuit (ASIC) in the power receiver 310 to execute the following steps:

Step 600: Start.

Step 602: Send a first packet including a security code of a portable electronic device to a power transmission device for starting wireless charging.

Step 604: Report a second packet including the security code to the power transmission device in response to receiving a command from the power transmission device.

Step 606: End.

According to the process 60, the portable electronic device 300 starts the wireless charging by the power receiver 310 sending a first packet with a security code which identifies the portable electronic device 300. Then, during wireless charging, the power transmission device 320 may send a command to the portable electronic device 300 if reporting the security code again is necessary. In normal conditions, the security code included in the second packet which is transmitted in response to the command should match the security code included in the first packet. If the power transmission device 320 receives another security code in the second packet which does not match the security code included in the first packet, the power transmission device 320 may determine that an abnormal condition happens and may activate certain functions to protect the portable electronic device 300. Please note that, the power receiver 310 may report the second packet including the security code to the power transmission device 320, in response to a command from other controller of the wireless charging system 30 than from the power transmission device 320. The controller maybe included in any other device of the wireless charging system except the power receiver 310. A central microprocessor of a mobile phone (i.e. the portable electronic device 300) or a remote control device in the wireless charging system, for example, may send a command to the power receiver 310 to trigger the power receiver 310 to report the second packet including the security code.

Note that the process 60 is an example of the present invention. Combinations, modifications and/or alterations similar to the description and examples for the processes 40 and 50 may be applied to the process 60 as well. In addition, the command for requesting the portable electronic device 300 to report the security code may instruct the portable electronic device 300 to transmit the security code with other information in the second packet. The second packet could be a regular packet communicated from the portable electronic device 300 to the power transmission device 320 such as the Control Error Packet, or a special packet dedicated for reporting the security code.

The abovementioned steps of the processes 40, 50 and 60 including suggested steps may be realized by means of hardware, software, firmware, or an electronic system. Examples of hardware may include analog, digital and mixed circuits known as microcircuit, microchip, or silicon chip. Examples of the electronic system may include a system on chip (SOC), system in package (SiP), and a computer on module (COM).

To sum up, the present invention utilizes a security code representing an identity of a portable electronic device in a wireless charging system and requires the portable electronic device to report the security code for identification check during wireless charging. Therefore, the power transmission device in the wireless charging system is able to detect whether the portable electronic device is replaced and take actions to protect the portable electronic device in a timely manner.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a portable electronic device for enhancing the security of the portable electronic device while charged wirelessly by a power transmission device in a wireless charging system, the method comprising:
sending a first packet including a security code of the portable electronic device to the power transmission device for starting wireless charging;
being charged wirelessly by the power transmission device; and
reporting a second packet including the security code to the power transmission device according to a triggering event.

2. The method of claim 1, wherein the triggering event comprises stopping wireless charging, phase transition, missing packet, receiving unexpected packet, decoding packet incorrectly, or a timeout event.

3. The method of claim 1, wherein the step of reporting the second packet including the security code to the power transmission device according to the triggering event comprises:
constantly reporting the second packet including the security code to the power transmission device while being charged wirelessly by the power transmission device.

4. The method of claim 3, wherein the portable electronic device reports the second packet including the security code to the power transmission device periodically or non-periodically.

5. The method of claim 3, wherein the second packet is a Control Error Packet defined by Wireless Power Consortium (WPC).

6. The method of claim 1, wherein the triggering event is generated by a command received from the power transmission device or a controller of the wireless charging system.

7. The method of claim 1, wherein the security code comprises full, partial or a logic operation of the manufacture code of the portable electronic device, the basic device identifier of the portable electronic device, the extended device identifier of the portable electronic device and/or an identity of the portable electronic device, and/or a code assigned by the power transmission device or generated by the portable electronic device.

8. The method of claim 1, wherein the first or the second packet carries the security code only, the security code plus other information, or the other information encoded with the security code.

9. The method of claim 1, wherein the triggering event is stopping wireless charging.

10. The method of claim 1, wherein the second packet is an End Power Transfer packet defined by Wireless Power Consortium (WPC) inserted with the security code, or a dedicated packet including only the security code transmitted right behind the End Power Transfer packet.

11. A method for a portable electronic device for enhancing the security of the portable electronic device while charged wirelessly by a power transmission device in a wireless charging system, the method comprising:
sending a first packet including a security code of the portable electronic device to the power transmission device for starting wireless charging; and
constantly reporting a second packet including the security code to the power transmission device while being charged wirelessly by the power transmission device.

12. The method of claim 11, wherein the portable electronic device reports the second packet including the security code to the power transmission device periodically or non-periodically.

13. The method of claim 11, wherein the second packet is a Control Error Packet defined by Wireless Power Consortium (WPC).

14. The method of claim 11, wherein the portable electronic device constantly reports the second packet including the security code to the power transmission device according to a command received from the power transmission device or a controller of the wireless charging system.

15. The method of claim 11, wherein the security code comprises full, partial or a logic operation of the manufacture code of the portable electronic device, the basic device identifier of the portable electronic device, the extended device identifier of the portable electronic device and/or an identity of the portable electronic device, and/or a code assigned by the power transmission device or generated by the portable electronic device.

16. The method of claim 11, wherein the first or the second packet carries the security code only, the security code plus other information, or the other information encoded with to the security code.

17. A method for a power transmission device for enhancing the security of a portable electronic device while wirelessly charging to the portable electronic device, the method comprising:
receiving a first packet including a first security code of the portable electronic device from the portable electronic device for requesting wireless charging;
wirelessly transmitting power to the portable electronic device;
after receiving a second packet including a second security code, determining whether the second security code included in the second packet matches the first security code included in the first packet; and
activating a protection function after the power transmission device determines that the second security code in the second packet does not match the first security code in the first packet.

18. The method of claim 17, wherein the protection function comprises at least one of releasing a warning signal, launching a function for reporting a location of the portable electronic device, and sending a message for asking help.

19. The method of claim 17, wherein the first security code comprises full, partial or a logic operation of the manufacture code of the portable electronic device, the basic device identifier of the portable electronic device, the extended device identifier of the portable electronic device and/or an identity of the portable electronic device, and/or a code assigned by the power transmission device or generated by the portable electronic device.

20. The method of claim 17, wherein the first packets carries the first security code only, the first security code plus other information, or the other information encoded with the first security code.
